(19) United States
(12) Patent Application Publication
(10) Pub. No.: US 2009/0014429 A1
(43) Pub. Date: Jan. 15, 2009

(54) Heating Element for Baking Ovens

(76) Inventor: Lothar Pasch, Terborg (NL)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/997,254

(22) PCT Filed: Jul. 11, 2006
(86) PCT No.: PCT/NL2006/000353

§ 371 Date: Oct. 3, 2008

(30) Foreign Application Priority Data
Jul. 28, 2005 (NL) 1029641

(51) Int. Cl. A21B 1/14

(52) U.S. Cl. 219/409; 219/553; 219/540

(57) ABSTRACT

Heating element for ovens for food products, more particularly for ovens for bakery products, comprising a series of tubes placed adjacent to each other for guiding through heating fluid, which tubes have been made of heat conducting material, wherein tubes form first passages for the heating fluid that extend from a supply conduit for heating fluid to a turning point and form adjacently positioned second passages for heating fluid that extend from the turning point to a discharge conduit for heating fluid, wherein the discharge conduit and the supply conduit are situated at the same end of the tubes, wherein each first passage at the turning point is in fluid connection with a related second passage for forming the flow turning point.

The invention relates to a heating element for ovens, particularly baking ovens for food products.

In the food industry, particularly bakeries and other enterprises producing dough products, use is made of either large, elongated ovens in which the dough containing products are baked, often storey-wise, while being conveyed from an entrance to an exit, or smaller ovens, in which the products are treated stationary.

Above and/or below (in case of a horizontal movement or stationary positioning of the products in the oven) and/or at the side (in case of a vertical movement of the products) of the path/location of the products, heating elements have been positioned. They heat the products by means of radiation and optionally convection. They may be provided with passages for passing through of a heating medium, particularly oil.

For this purpose a heating plate is known that has been built up from two plates provided with ducts, which plates have been placed against each other in order for opposite ducts to form oil passages. At the edges the plate has been provided with connections for conduits to and from an oil heating unit positioned at or spaced apart from the oven. Between the ducts the plate may be provided with holes for convection.

Ovens are not a standard product, but nearly always adapted to the products and to the specific bakery process to be carried out, that is closely related to the nature of the product to be baked. The known heating plate therefore has to be custom-made, each time having other dimensions. As a result the manufacturing of the (many) heating plates for a specifically ordered oven is time-consuming.

Another disadvantage is the temperature gradient that may be present over the heating plate, as a result of which products that are moved along or are situated near an area of the heating plate are baked differently from the products that are moved along or are situated near an area that is spaced apart from said heating plate.

It is an object of the invention to improve on at least a number of those points.

From one aspect the invention to that end provides a heating element for ovens, more particularly for ovens for bakery products, comprising a series of tubes placed adjacent to each other for guiding through heating fluid, which tubes have been made of heat conducting material, wherein tubes form first passages for the heating fluid that extend from a supply conduit for heating fluid to a turning point and form adjacently positioned second passages for heating fluid that extend from the turning point to a discharge conduit for heating fluid, wherein the discharge conduit and the supply conduit are situated at the same end of the tubes, wherein each first passage at the turning point is in fluid connection with a related second passage for forming the flow turning point.

In this way the first and second passages are connected to each other via an own connection, so that no exchange of heating fluid with the adjacent flow paths takes place. It is thus achieved that in two consecutive trajectories that are in series with each other and in which heat is emitted by the fluid in the tubes the temperature gradient is oppositely oriented, as a result of which along the tube in question on balance an evenly distributed heat emission over the length can occur.

In one embodiment each tube of the series comprises its own flow path for the fluid comprising a first passage, a second passage, and a flow turning point connecting said first and second passage.

The heating element is easy to assemble, starting from a desired length of conduit for the supply and/or discharge, onto which a desired series of tubes can be attached. In this case it regards a simple and easily adaptable assembly technique.

If the discharge and the supply are situated above each other an equal length of the first passage and the second passage is realised in a simple way.

Preferably the tubes are situated in the same plane, preferably in a substantially flat plane as a result of which a flat shape is achieved that is easy to incorporate in an oven.

In a first further development of the heating element according to the invention the first passages and the second passages are situated adjacent to each other, considered in a direction in which the tubes are situated adjacent to each other, in which way an even distribution of the temperature is enhanced.

In an alternative, second further development of the heating element according to the invention the first passages and the second passages are situated adjacent to each other, considered in a direction perpendicular to the one in which the tubes are situated adjacent to each other, as a result of which the connection to supply and discharge situated adjacent to each other in that direction can be simple.

The first passages and the second passages may have been formed within an optionally composite tube and over at least their full length may be separated from each other by at least one wall, which preferably is a longitudinal partitioning wall accommodated in a tube. Said wall can simply be inserted at one end of the tube, in which way assembly is facilitated.

The wall may be heat-insulating, and for that purpose preferably is double-walled, including an air chamber. In this way heat exchange between both passages is counteracted.

In an easy-to-assemble embodiment the tubes at their end of the turning point have been provided with a turning piece, such as a cap, attached to the tube end. The tubes can easily be brought at the desired length and then be provided with the turning piece.

In one embodiment the tubes have a flattened cross-section, such as an oval or elliptic cross-section, resulting in an advantageous radiation surface.

In one embodiment the tubes have a square cross-section, wherein the diagonals extend parallel and perpendicular, respectively, to the plane of the series of tubes placed adjacent to each other.

A convection effect can easily be achieved when the tubes are positioned adjacent to each other and spaced apart from each other.

In one embodiment the supply passage and the discharge passage, for the supply and discharge, respectively, of the fluid, can be formed within an optionally composite conduit, and over at least their full length be separated from each other by at least one wall, which preferably is a longitudinal partitioning wall accommodated in the conduit. By combining the supply and discharge in one conduit a compact heating element having little thickness, at least considered in a direction perpendicular to the one in which the tubes are situated adjacent to each other, can be achieved.

The heating element is easy to assemble by arranging openings in the wall of the conduit and in the longitudinal partitioning wall, and wherein the series of tubes extend through these openings and are connected with the conduit. In this case the first and second passages are in fluid connection with the supply passage and the discharge passage, respectively.

In an alternative and simple embodiment the supply passage and the discharge passage have each been placed in a separate supply conduit and discharge conduit. In that case the discharge conduit and the supply conduit preferably are situated above each other on either side of the series of tubes or situated adjacent to each other on one side of the series of tubes.

Assembly into larger units is facilitated when the supply and discharge at their ends have been provided with means for connection to similar other heating elements, optionally with expansion compensator.

The invention furthermore provides an oven for food products provided with a number of heating elements according to the invention.

The invention will be elucidated on the basis of an exemplary embodiment shown in the attached drawings, in which:

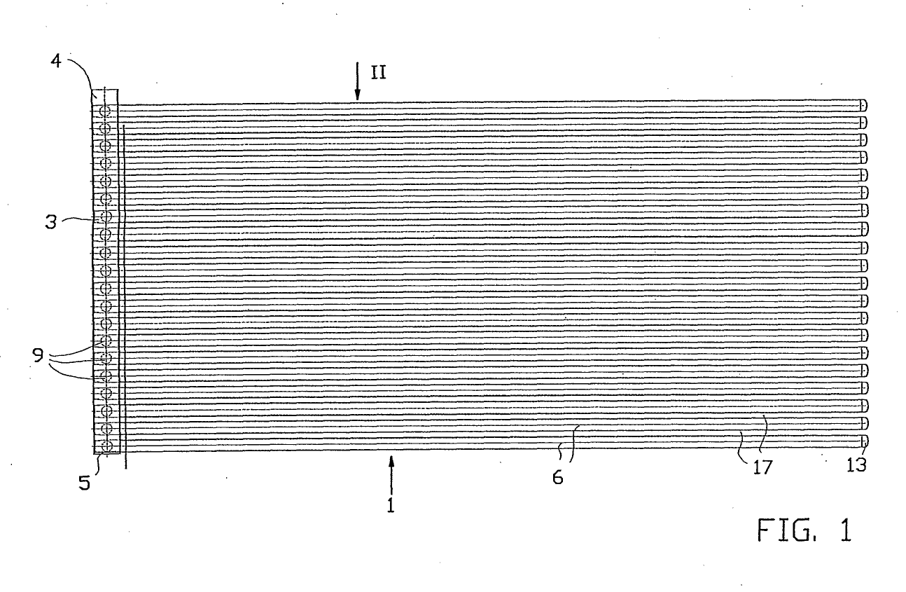

FIG. 1 shows a top view of an exemplary embodiment of a heating element according to the invention;

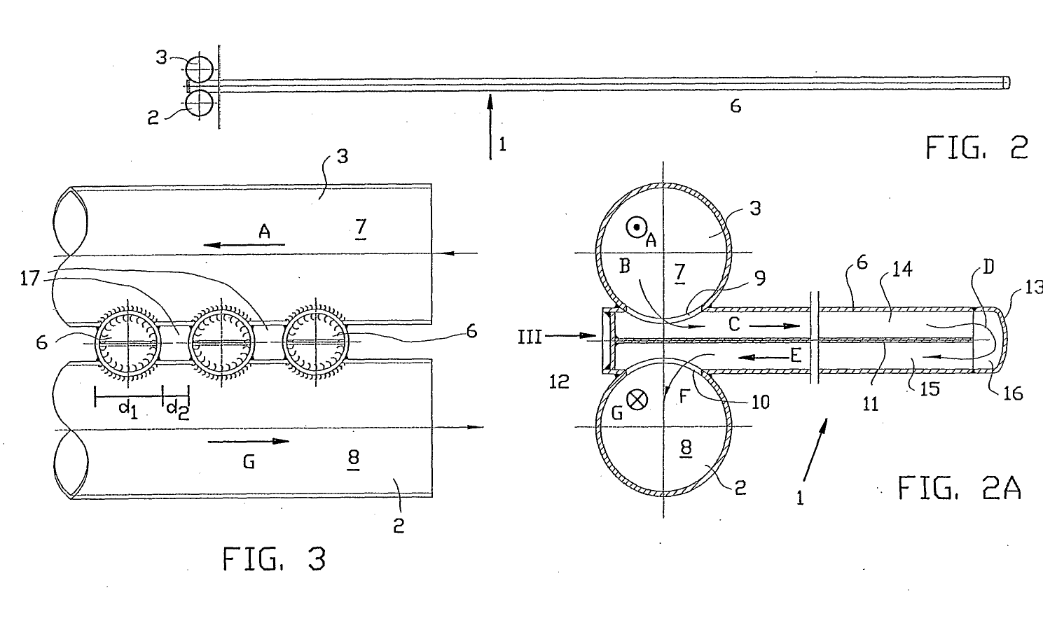

FIG. 2 shows a side view of the heating element of FIG. 1;

FIG. 2A shows a shortened, enlarged view corresponding with FIG. 2 of the heating element of FIG. 1;

FIG. 3 shows a partial detail according to model III in FIG. 2A;

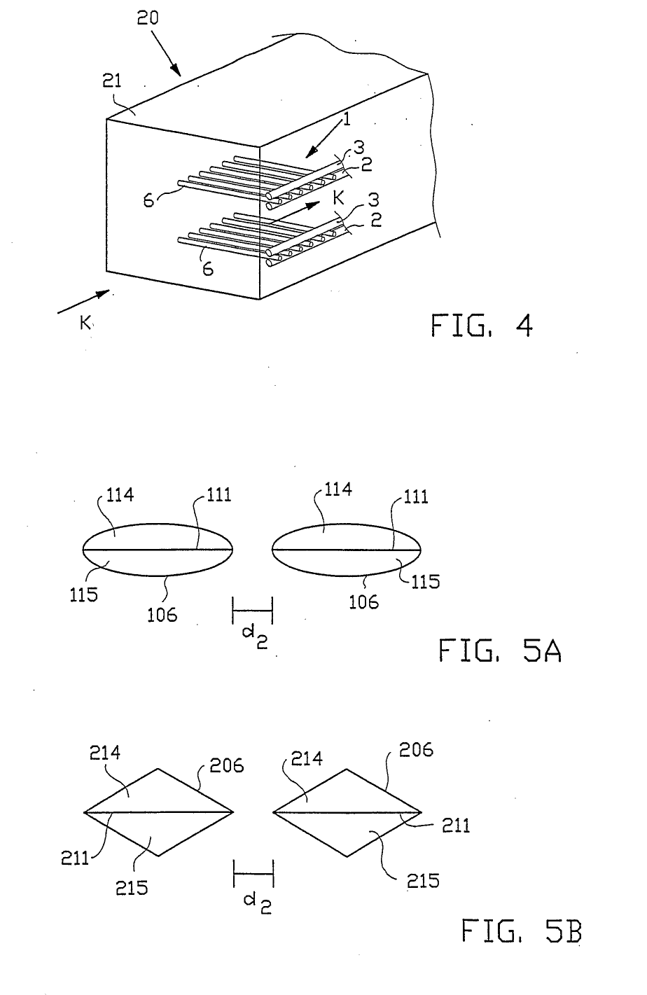

FIG. 4 shows a schematic view in perspective of an oven for food products including a heating element according to FIG. 1;

FIGS. 5A and 5B show alternative cross-sections of tubes in a heating element according to the invention;

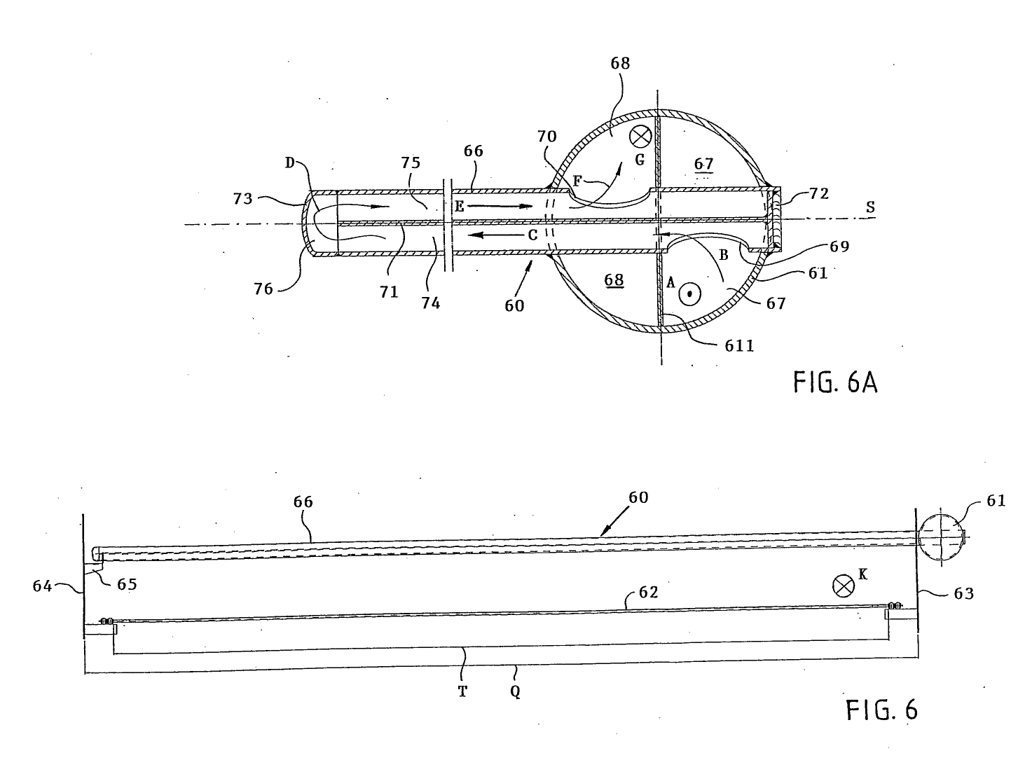

FIG. 6 shows a side view of a further exemplary embodiment of a heating element according to the invention; and

FIG. 6A shows a shortened, enlarged view in cross-section of the heating element corresponding with FIG. 6.

FIGS. 1 and 2 show the heating element 1, having the form of a module and which at one side is provided with a relatively wide discharge tube 2 and a supply tube 3 placed above it and having passages 7 and 8 for heating fluid, particularly oil. Both tubes 2 and 3 may at the ends 4 and 5 be connected to other, particularly identical heating elements or to supply/discharge conduits.

A series of heating tubes 6 has been attached on both tubes 2 and 3 which heating tubes are thinner and extend transverse to said tubes 2 and 3 and which at the end at the tubes 2 and 3 have been provided with an inlet opening 9 and an exit opening 10, which, as can be seen in FIG. 2A, are situated above each other. In the tube 6 a partitioning wall 11 has been inserted, in this example situated parallel to the plane defined by the tubes 6, which partitioning wall 11 at one end has been provided with a partition 12, that can be welded fixed to an end of the tube 6. At the other end of the tube 6 a turning piece 13 has been welded fixed, as a result of which the tube 6—including turning piece 13—defines a flat U-shaped flow path, through a first passage 14, a turning passage 16 and a second passage 15.

As can be seen in FIGS. 1 and 3 the tubes 6 may be slightly spaced apart, wherein in this example d1, is the diameter of the tube 6, and d2 the intermediate distance between the tubes 6.

The heating elements in a connected series, as stated, have been accommodated in an oven 20 (FIG. 4) within the framework 21 thereof. In this case series of heating elements 1 can be situated above each other, with their main plane horizontal, in between which a horizontal product flow is then able to move, in a way that is not further shown, in the direction K. The supply and discharge tubes 2, 3 are connected in way that is neither particular nor further shown to a heating unit for heating the oil flowing through the heating elements 1, as well as a pump unit for it. It is noted that in other ovens the heating elements can be placed with their main plane vertical, wherein the products are moved vertically, in between the heating elements placed on either side of said movement path.

During use the oil flows in the direction A through the passage 7 of the supply tube 3, and then enters through inlet 9 in the direction B, subsequently flows in the direction C through the first passage 14, subsequently the flow is reversed in passage 16 according to arrow D, in order to flow back in second passage 15 in the direction E, and via outlet 10 end up in the passage 8 of the discharge tube 2 in order to flow onwards therein in the direction G to the heating unit and pump unit.

The longitudinal partition 11 may be heat insulating. The temperature differences over the distance between the inlet 9 and the turning piece 13 and the distance between the turning piece 13 and the outlet 10 are substantially identical to each other. On average the temperature drop will as a result be constant over the length of the tube 6, as a result of which the food products to be baked moving over a path oriented transverse over the tube 6, near the turning point, will be subjected to the same temperature influences as the food products that move according to a path that is parallel and situated more spaced apart therefrom, particularly near the supply/discharge tube 3, 2.

If, like in the example shown, an opening d2 is present in the tubes 6, there is room for a convection movement. If d2 is nil the heating element will only function as radiation element.

In FIG. 5A elliptic cross-sections of alternative tubes 106 for heating element 1 are shown, wherein the longest axis is parallel to the plane of the tubes, wherein partitioning wall 111 divides the internal space of the tube 106 into a first passage 114 situated above and a second passage 115 situated below. The tubes 106 are spaced apart from each other at a distance d2.

In FIG. 5B the tubes 206 are square, wherein a horizontal partition 211 divides the internal space of the tubes 206 in an upper first passage 214 and a lower second passage 215.

As indicated before the longitudinal partitions may be vertically positioned instead of horizontally.

In FIG. 6 a further exemplary embodiment of a heating element 60 is shown, which has a shape comparable to the module as shown in FIG. 1, wherein one edge is provided with a supply and discharge conduit 61. The heating element 60 is placed in an oven having an internal oven width O, wherein the supply and discharge conduit 61 has been placed outside of the processing space of the oven. Underneath the heating element 60 a conveyor device 62 has been placed for passing the product to be baked through the oven. The width T of the carrying part of the conveyor device 62 defines the maximum product width that can be passed through the oven.

Near the supply and discharge conduit 61 the modular heating element 60 is supported by the oven wall 63 and at the other side the heating tubes 66 are supported by a support 65, which has been placed at the inside of the oven wall 64.

In the supply and discharge conduit 61 a partitioning wall 611 has been inserted, which in this example is situated perpendicular to the plane defined by the tubes 66, which partitioning wall divides the supply and discharge conduit 61 into a supply passage 67 and a discharge passage 68 for heating fluid. The supply and discharge conduit 61 may at one or more of its ends be connected to other, particularly identical heating elements or to supply/discharge conduits.

For placing the series of heating tubes 66, through-openings have been arranged in the supply and discharge conduit 61 and in the partitioning wall 611, which through-openings are in line and have a diameter that substantially equals the diameter of the heating tubes 66. The heating tubes 66 can be inserted through these openings, after which they are connected to the supply and discharge conduit 61 by means of a fluid-proof connection, such as for instance a welded joint. Because of this structure the heating elements 66, when being placed in the supply and discharge conduit 61, can be placed at any angle around the axis of symmetry S for obtaining an optimal temperature distribution over the plane defined by the series of heating tubes 66. After welding the heating tubes 66 to the supply and discharge conduit 61 the orientation of these heating tubes 66 around the axis of symmetry S is fixed.

In this example the partitioning wall 71 is substantially parallel to the plane defined by the tubes 66. In an alternative embodiment the partitioning wall 71 may for instance also be placed perpendicular to the plane defined by the tubes 66.

The heating tubes 66 as regards build-up, can be compared to the heating tubes as described above and shown in FIG. 2A. At a portion situated within the supply and discharge conduit 61 said heating tubes 66 are provided with a loading opening 69 and an outlet opening 70. A partitioning wall 71 has been inserted in the tube 66, which partitioning wall 71 at one end has been provided with a transverse partition 72. As described above the orientation of said partitioning wall 71 around the axis of symmetry S can be chosen freely during the manufacturing of the heating element 60.

At the other end of the tube 66 a turning piece 73 has been welded fixed, as a result of which the tube 66, with turning piece 73, defines a flat U-shaped flow path through a first passage 74, a turning passage 76 and a second passage 75.

During use the oil flows in a comparable manner, as described above, in the direction A through supply passage 67, via the passage B, C, D, E and F in the heating tube 66 to the discharge passage 68 in the direction G.

1. Heating element for ovens comprising a series of tubes placed adjacent to each other for guiding through heating fluid, which tubes have been made of heat conducting material, wherein tubes form first passages for the heating fluid that extend from a supply for heating fluid to a turning point and form adjacently positioned second passages for heating fluid that extend from the turning point to a discharge for heating fluid, wherein the discharge and the supply are situated at the same end of the tubes, wherein each first passage at the turning point is in fluid connection with a related second passage for forming the flow turning point.

2. Heating element according to claim 1, wherein each of the series of tubes comprises a first passage, a second passage, and a flow turning point connecting said first and second passage.

3. Heating element according to claim 1 wherein the tubes are situated in the same plane.

4. Heating element according to claim 1 wherein the first passages and the second passages are situated adjacent to each other, considered in a direction in which the tubes are situated adjacent to each other.

5. Heating element according to claim 1, wherein the first passages and the second passages are situated adjacent to each other, considered in a direction perpendicular to the one in which the tubes are situated adjacent to each other.

6. Heating element according to claim 1, wherein the first passages and the second passages have been formed within an optionally composite tube and over at least their full length are separated from each other by at least one wall.

7. Heating element according to claim 6, wherein the separation wall is a longitudinal partitioning wall accommodated in a tube, which partitioning wall preferably tapers towards the turning point.

8. Heating element according to claim 6, wherein the first passage and the second passage are separated from each other by an air chamber, defined between two separation walls, preferably converging towards the turning point.

9. Heating element according to claim 6, wherein the tubes at their end of the turning point have been provided with a turning piece, such as a cap, attached to the tube end.

10. Heating element according to claim 1, wherein one or more of the tubes have a flattened cross-section, such as an oval or elliptic cross-section.

11. Heating element according to claims 1, wherein one or more of the tubes have a square cross-section, wherein the diagonals extend parallel and perpendicular, respectively, to the plane of the series of tubes placed adjacent to each other.

12. Heating element according to claim 1, wherein the tubes are positioned adjacent to each other and spaced apart from each other.

13. Heating element according to claim 1, wherein the supply comprises a supply passage that is in fluid connection to the first passages, and wherein the discharge comprises a discharge passage that is in fluid connection with the second passages.

14. Heating element according to claim 13, wherein the supply passage and the discharge passage are situated adjacent to each other, considered in a direction perpendicular to the one in which the tubes are situated adjacent to each other.

15. Heating element according to claim 13, wherein the supply passage and the discharge passage extend substantially in a direction perpendicular to the tubes.

16. Heating element according to any one of the claims 13, wherein the supply passage and the discharge passage have each been placed in a separate supply conduit and discharge conduit.

17. Heating element according to claim 16, wherein the discharge conduit and the supply conduit are situated above each other, preferably on either side of the series of tubes.

18. Heating element according to claim 16, wherein the discharge conduit and the supply conduit are situated adjacent to each other, preferably on the same side of the series of tubes.

19. Heating element according to any one of the claim 13, wherein the supply passage and the discharge passage are formed within an optionally composite conduit, and over at least their full length are separated from each other by at least one wall.

20. Heating element according to claim 19, wherein said separation wall is a longitudinal partitioning wall accommodated in the conduit, and wherein the series of tubes extend in the conduit and through said separation wall.

21. Heating element according to claim 1, wherein the supply and discharge at their ends have been provided with means for connection to similar other heating elements, optionally with expansion compensator.

22-27. (canceled)
